(19) United States
(12) Patent Application Publication
(10) Pub. No.: US 2008/0319654 A1
(43) Pub. Date: Dec. 25, 2008

(54) System and method for effectively implementing an electronic navigation device

(75) Inventors: Peter Shintani, San Diego, CA (US); Milton Frazier, San Marcos, CA (US)

Correspondence Address: Gregory J. Koerner;Redwood Patent Law, 1291 East Hillsdale Boulevard, Suite 205, Foster City, CA, 94404, US

(73) Assignees: Sony Corporation; Sony Electronics Inc.

(21) Appl. No.: 11/821,417

(22) Filed: Jun. 22, 2007

(51) Int. Cl. G01C 21/32

(52) U.S. Cl. 701/208; 701/207; 340/995.1

(57) ABSTRACT

A system and method for effectively implementing an electronic navigation device includes a display coupled to the navigation device for displaying various appropriate types of map data corresponding to particular geographic locations. A map manager coordinates map update procedures to periodically realign the map data on the display based upon various types of device location data and device orientation data. The electronic navigation device is implemented to include a processor device that controls said map manager to perform the map update procedures.

### BACKGROUND SECTION

1. Field of the Invention

This invention relates generally to techniques for optimally presenting location information, and relates more particularly to a system and method for effectively implementing an electronic navigation device.

2. Description of the Background Art

Implementing effective methods for providing location information is a significant consideration for designers and manufacturers of contemporary electronic navigation devices. However, effectively presenting location information with electronic navigation devices may create substantial challenges for system designers. For example, enhanced demands for increased device functionality and performance may require more system processing power and require additional hardware resources. An increase in processing or hardware requirements may also result in a corresponding detrimental economic impact due to increased production costs and operational inefficiencies.

Furthermore, enhanced device capability to perform various advanced operations may provide additional benefits to a system user, but may also place increased demands on the control and management of various device components. For example, an enhanced electronic navigation device that effectively accesses, processes, and displays digital map data may benefit from an efficient implementation because of the large amount and complexity of the digital data involved. In addition, providing the location information to a device user in a manner that facilitates rapid assimilation and utilization of the location information may significantly benefit the device user.

Due to growing demands on device resources, substantially increasing data magnitudes, and the need for optimal utilization of location information by device users, it is apparent that developing new techniques for providing location information is a matter of concern for related electronic technologies. Therefore, for all the foregoing reasons, developing effective techniques for presenting location information remains a significant consideration for designers, manufacturers, and users of contemporary electronic navigation devices.

### SUMMARY

In accordance with the present invention, a system and method are disclosed for effectively implementing a navigation device. In one embodiment, a map manager of the navigation device accesses an initial set of location data from any appropriate location data source. For example, in certain embodiments, the location data may be provided by one or more location sensors that specifically detect the current physical location of the navigation device. The map manager utilizes the initial location data to determine an initial device location for navigation device. The map manager then accesses map data corresponding to the initial device location from a local memory of the navigation device, and displays the accessed map data in a predefined default map orientation upon a display of the navigation device.

Next, the map manager accesses new current location data from the location sensor or other appropriate location data source. In certain embodiments, the location sensor may include a standard or enhanced Global Positioning System (GPS) receiver. The map manager calculates an initial device orientation for the navigation device by utilizing any appropriate and effective techniques. For example, the map manager may determine the initial device orientation for the navigation device by utilizing the foregoing initial location data and current location data.

The initial device orientation calculated by the map manager may be stored as an initial set of orientation data in the local memory of the navigation device. The map manager may then perform a map-orientation update procedure to update the initial map orientation of the map data on display. The foregoing map-orientation update procedure thus provides an updated map orientation that is aligned with the calculated initial device orientation.

In certain embodiments, the map manager may then monitor the location data generated by the location sensor(s) of the navigation device by utilizing any effective means or techniques. The map manager determines whether any change has occurred in the location data stored from location sensor(s) 120 into the local memory. If no change has occurred in the location data, then the map manager continues to monitor the location data for any changes. However, if a change has occurred in the location data, then the map manager recalculates a current device orientation for the navigation device by utilizing any appropriate techniques. For example, the map manager may quantify the current device orientation by utilizing the two most-recent sets of location data. In certain embodiments, the current device orientation may be stored as orientation data in the local memory.

Next, the map manager determines whether any change has occurred in the current device orientation with respect to the immediately preceding device orientation by utilizing any effective techniques. For example, the map manager may compare the corresponding respective sets of orientation data to detect a change in device orientation. If no change has occurred in the device orientation, then the map manager continues to monitor the location data for any changes.

However, if a change has occurred in the device orientation, then the map manager may perform a map-orientation update procedure to update the current map orientation of the map data on the display. The foregoing map-orientation update procedure thus provides an updated map orientation that is aligned with the current calculated device orientation. The map manager may then continue to monitor the location data for any further changes.

In certain embodiments, the map manager may also monitor the orientation data generated by one or more orientation sensors of the navigation device by utilizing any effective means or techniques. In certain embodiments, the orientation sensors may be implemented to include a magnetic compass device and/or an inertial sensor device. The map manager determines whether any change has occurred in the orientation data stored from the orientation sensor(s) into the local memory by utilizing any appropriate techniques. For example, the map manager may directly compare the two most-recent sets of orientation data to detect a change in device orientation of the navigation device.

If no change has occurred in the orientation data, then the map manager may continue to monitor the orientation data for any changes. However, if a change has occurred in the orientation data, then the map manager may perform a map-orientation update procedure to update the current map orientation of the map data on the display. The foregoing map-orientation update procedure thus provides an updated map orientation that is aligned with the current device orientation. The map manager may then continue to monitor the orientation data for any further changes.

The present invention may thus be advantageously implemented to facilitate directly viewing map data on the navigation device in a correctly-aligned map orientation, without requiring the device user to inconveniently visualize and mentally transpose traveling directions and map coordinates during a given course of travel. For all of the foregoing reasons, the present invention provides an improved system and method for effectively implementing an electronic navigation device.

### BRIEF DESCRIPTION OF THE DRAWINGS

FIG. 1 is a block diagram for one embodiment of a navigation device, in accordance with the present invention;

FIG. 2 is a block diagram for one embodiment of the memory of FIG. 1, in accordance with the present invention;

FIGS. 3A and 3B are diagrams illustrating an orientation vector for the navigation device of FIG. 1, in accordance with several embodiments of the present invention;

FIG. 4 is a block diagram for one embodiment of the location data of FIG. 2, in accordance with the present invention;

FIG. 5 is a block diagram for one embodiment of the orientation data of FIG. 2, in accordance with the present invention;

FIGS. 6A and 6B are diagrams illustrating map data displayed on the display of FIG. 1, in accordance with several embodiments of the present invention;

FIG. 7A is a flowchart of method steps for determining an initial device orientation for the navigation device of FIG. 1, in accordance with one embodiment of the present invention;

FIG. 7B is a flowchart of method steps for utilizing location data to update map data on the display of FIG. 1, in accordance with one embodiment of the present invention; and

FIG. 8 is a flowchart of method steps for utilizing orientation data to update map data on the display of FIG. 1, in accordance with one embodiment of the present invention.

### DETAILED DESCRIPTION

The present invention relates to an improvement in techniques for presenting location information on an electronic navigation device. The following description is presented to enable one of ordinary skill in the art to make and use the invention and is provided in the context of a patent application and its requirements. Various modifications to the disclosed embodiments will be readily apparent to those skilled in the art, and the generic principles herein may be applied to other embodiments. Thus, the present invention is not intended to be limited to the embodiments shown, but is to be accorded the widest scope consistent with the principles and features described herein.

The present invention comprises a system and method for effectively implementing an electronic navigation device, and includes a display coupled to the navigation device for displaying various appropriate types of map data corresponding to particular geographic locations. A map manager advantageously coordinates map update procedures to periodically realign the map data on the display based upon various types of device location data and device orientation data. The electronic navigation device is implemented to include a processor device that controls said map manager to perform the map update procedures.

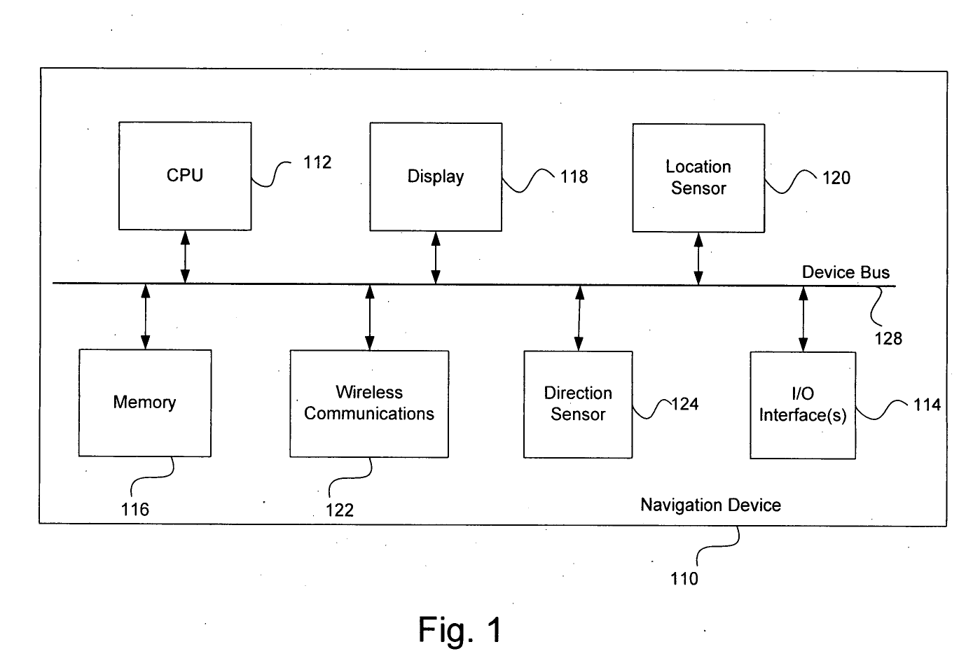

Referring now to FIG. 1, a block diagram for one embodiment of a navigation device 110 is shown, in accordance with the present invention. In the FIG. 1 embodiment, navigation device 110 includes, but is not limited to, a central processing unit (CPU) 112, one or more input/output (I/O) interfaces 114, memory 116, a display 118, one or more location sensors 120, an optional wireless communications module 122, and one or more direction sensors 124. The foregoing components of navigation device 110 may be coupled to, and communicate through, a device bus 128.

In alternate embodiments, navigation device 110 may be implemented using various components and configurations in addition to, or instead of, certain of those components and configurations discussed in conjunction with the FIG. 1 embodiment. Furthermore, navigation device 110 may be implemented as any appropriate type of electronic device. For example, navigation device 110 may be implemented as an vehicle navigation system, a personal digital assistant (PDA), a cellular telephone, or as a personal computer device.

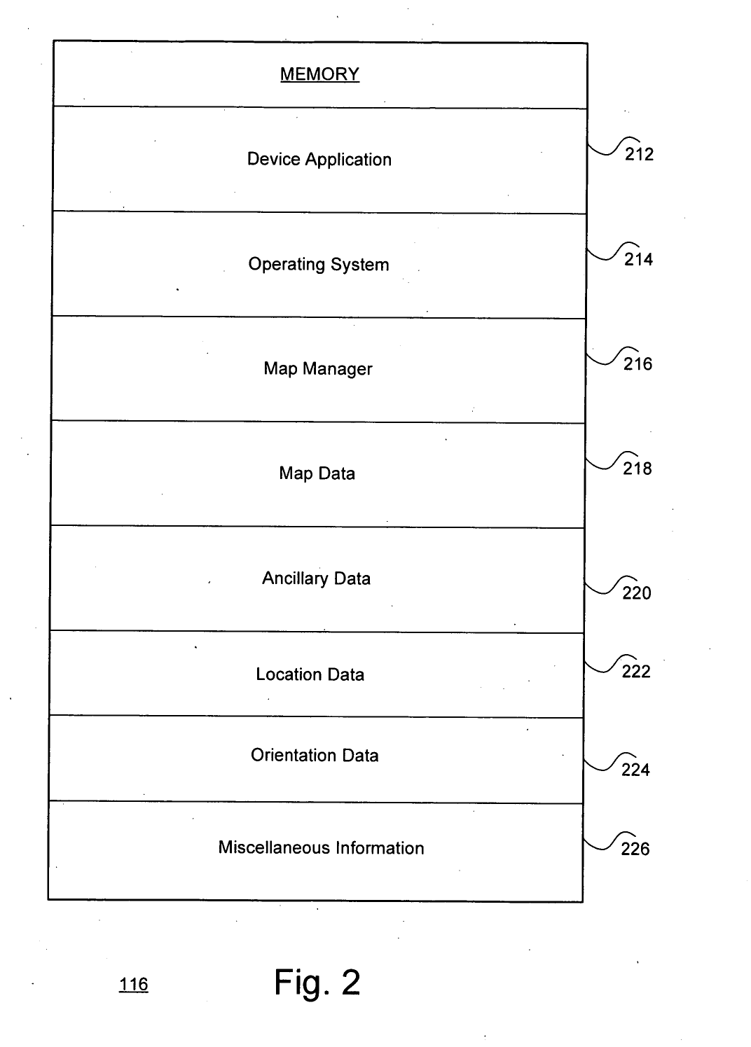

In the FIG. 1 embodiment, CPU 112 may be implemented to include any appropriate and compatible microprocessor device that executes software instructions to control and manage the operation of navigation device 110. The FIG. 1 display 118 may include any effective type of display technology including a cathode-ray-tube monitor, an LCD device, or an OLED device. In the FIG. 1 embodiment, memory 116 may be implemented to include any combination of desired storage devices, including, but not limited to, read-only memory (ROM), random-access memory (RAM), and various types of non-volatile memory, such as floppy disks or hard disks. The contents and functionality of memory 116 are further discussed below in conjunction with FIGS. 2 and 4-5.

In the FIG. 1 embodiment, I/O interface(s) 114 may include any effective means to allow a system user to communicate with navigation device 110. For example, I/O interface(s) 114 may support a keyboard device, a wireless remote control device, a speech-recognition module with corresponding microphone, a graphical user interface with touch-screen capability, and a selection button array mounted externally on navigation device 110.

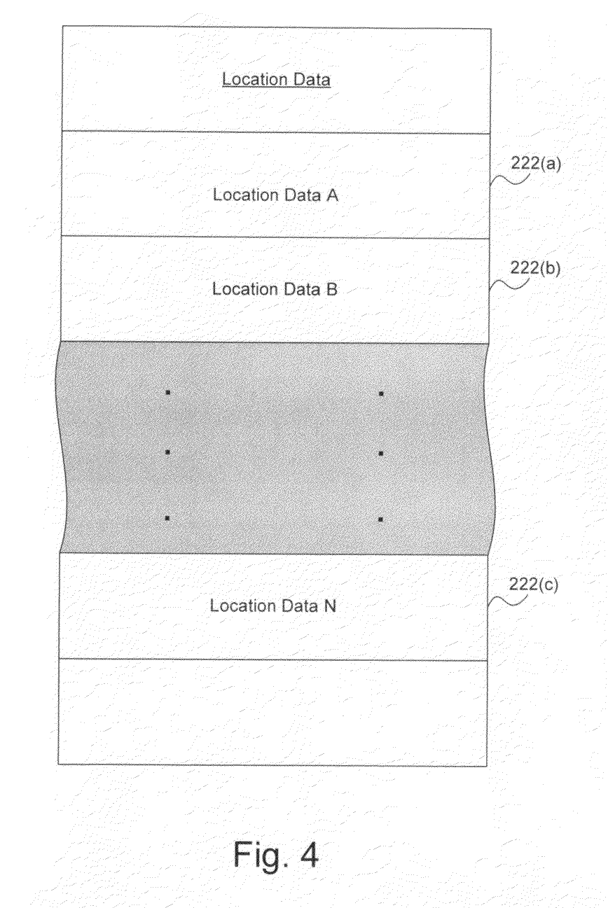

In the FIG. 1 embodiment, location sensor 120 may be implemented in any effective manner to receive and process any required types of relevant location information for use by navigation device 110. For example, location sensor 120 may include a standard or enhanced Global Positioning System (GPS) receiver to generate location data corresponding to a current physical location of navigation device 110. Further details regarding the location data are discussed below in conjunction with FIG. 4.

In the FIG. 1 embodiment, direction sensor 124 may be implemented in any effective manner to receive and process any required types of relevant orientation information for use by navigation device 110. For example, orientation sensor 124 may include a standard or enhanced magnetic compass that provides orientation data corresponding to a current device orientation of navigation device 110. In certain embodiments, direction sensor 124 may include an inertial orientation sensor in which a starting point, all accelerations, and all changes of direction may be detected to determine a current device orientation of navigation device 110. Orientation sensor 124 may further utilize various types of orientation data generated by vehicle sensors such as wheel angle sensors and wheel rotation sensors to determine a current device orientation for navigation device 110.

In the FIG. 1 embodiment, wireless communications 122 may include any effective means to remotely communicate with an external entity such as an Internet server or Local Area Network (LAN) server, to thereby exchange relevant information for the operation of navigation device 110. For example, in certain embodiments, navigation device 110 may advantageously utilize a wireless communications module 122 to access an appropriate entity on a distributed computer network. Navigation device 110 may then download relevant or desired information, such as additional map data corresponding to a particular location of interest, updated software, or ancillary data. Navigation device 110 may thus store a reduced amount of map data to thereby conserve valuable memory resources. In addition, if wireless communications are available, navigation device 110 may utilize various types of more accurate differential GPS technologies. Further details regarding the functionality and operation of navigation device 110 are further discussed below in conjunction with FIGS. 2 through 8.

Referring now to FIG. 2, a block diagram for one embodiment of the FIG. 1 memory 116 is shown, in accordance with the present invention. In the FIG. 1 embodiment, memory 116 includes, but is not limited to, a device application 212, an operating system 214, a map manager 216, map data 218, ancillary data 220, location data 222, orientation data 224, and miscellaneous information 226. In alternate embodiments, memory 116 may include various other components or functionalities in addition to, or instead of, certain of those components or functionalities discussed in conjunction with the FIG. 2 embodiment.

In the FIG. 2 embodiment, device application 212 may include software instructions that are preferably executed by CPU 112 (FIG. 1) to perform various functions and operations for navigation device 110. The particular nature and functionality of device application 212 typically varies depending upon factors such as the specific type and particular use of the corresponding navigation device 110. In the FIG. 2 embodiment, operating system 214 controls and coordinates low-level functionality of navigation device 110.

In the FIG. 2 embodiment, map manager 216 advantageously coordinates and manages displaying appropriate map data 218 upon a display 118 of navigation device 110. Map data 218 may be formatted and configured in any effective manner to represent appropriate physical characteristics of corresponding geographical areas. For example, in certain embodiments, map data 218 may include appropriate way points that provide a rudimentary view of at least one course of travel. Ancillary data 220 may include any additional types of information that map manager 216 may require for enhancing the operation of navigation device 110. For example, ancillary data 220 may include, but is not limited to, location addresses, telephone numbers, local attractions, local landmarks, and personal contact information, etc.

In the FIG. 2 embodiment, location data 222 may include any type of relevant data or information regarding the present or past physical locations of navigation device 110. Additional details regarding location data 222 are further discussed below in conjunction with FIG. 4. In the FIG. 2 embodiment, orientation data 224 may include any type of relevant data or information regarding the present or past physical orientations of navigation device 110. Additional details regarding orientation data 224 are further discussed below in conjunction with FIG. 4.

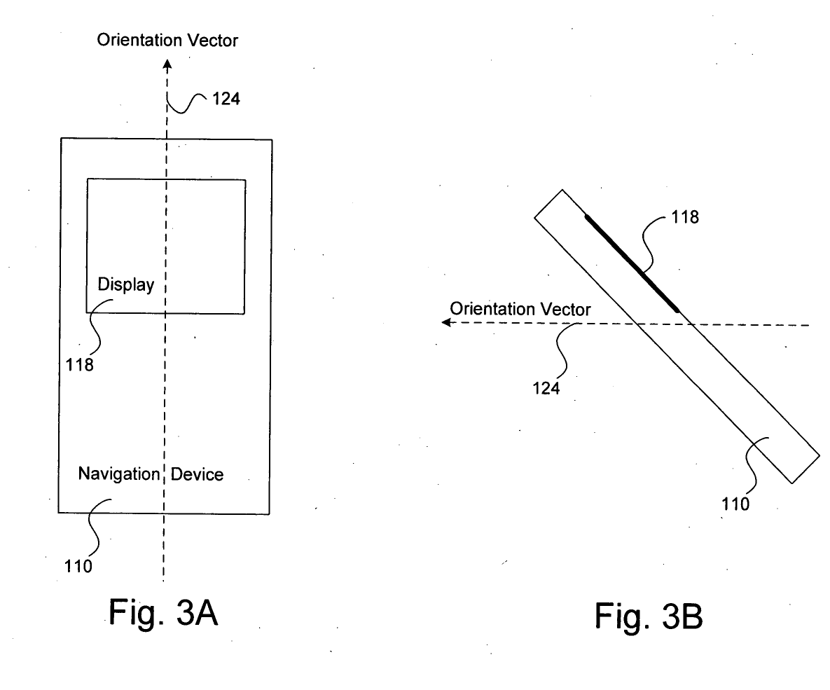

In the FIG. 2 embodiment, miscellaneous information 226 may include any appropriate additional information, data, or software to facilitate or enhance the operation of navigation device 110. For example, in certain embodiments, miscellaneous information 226 may include a magnetic-North/true-North conversion table that map manager 216 may reference to convert magnetic-North compass readings to true-North map coordinates (orientation data 224) for accurately displaying map data 218, in accordance with the present invention. Additional details regarding the functionality and operation of map manager 216 are further discussed below in conjunction with FIGS. 3 through 8.

Referring now to FIGS. 3A and 3B, diagrams illustrating an orientation vector 124 for the FIG. 1 navigation device 110 are shown, in accordance with one embodiment of the present invention. In alternate embodiments, the present invention may utilize other techniques and configurations in addition to, or instead of, certain of those techniques and configurations discussed in conjunction with the embodiments of FIGS. 3A and 3B.

In the FIG. 3A embodiment, a frontal view of navigation device 110 is shown with an orientation vector 124 that passes vertically from the bottom center to the top center of display 118. In the FIG. 3A embodiment, orientation vector 124 may be defined by map manager 216 or a device user to indicate a current direction of travel for navigation device 110. In alternate embodiments, orientation vector 124 may be associated with other user-selectable parameters such as a device user's direction of view. In the FIG. 3A embodiment, map manager 216 (FIG. 2) may align map data 218 with reference to orientation vector 124 to thereby provide the map data 218 with a map orientation that is synchronized to the current direction of travel for navigation device 110.

In the FIG. 3B embodiment, a tilted side-view of navigation device 110 is shown with an orientation vector 124 that passes horizontally from the right to left through navigation device 110. In the FIG. 3B embodiment, orientation vector 124 may be defined by map manager 216 or a device user to indicate a current direction of travel for navigation device 110 when navigation device 110 is tilted to facilitate viewing by a device user. In alternate embodiments, orientation vector 124 may be associated with other user-selectable parameters such as a device user's direction of view. In the FIG. 3B embodiment, map manager 216 (FIG. 2) may align map data 218 with reference to orientation vector 124 to thereby provide the map data 218 with a map orientation that is synchronized to the current direction of travel for navigation device 110.

In certain embodiments, a device user may selectively choose and store an appropriate degree of vector tilt (as shown in FIG. 3B) for orientation vector 124, depending upon the preferred or typical viewing position for navigation device 110. In addition, in alternate embodiments, gravitational sensors or other appropriate sensors may be utilized to automatically maintain a vector tilt for orientation vector 124 that results in orientation vector 124 being substantially horizontal and parallel to the Earth's surface.

Referring again to the FIG. 3A embodiment, a device user may also selectively choose and store an appropriate degree of vector rotation for orientation vector 124, depending upon the preferred or typical viewing position for navigation device 110. For example, if a passenger in an automobile is viewing navigation device 110 from a right-front passenger seat, then a vector rotation may be selected to align orientation vector 124 with the direction of travel, while still allowing navigation device 110 to be rotated towards the automobile passenger seat for easier viewing. In certain embodiments, orientation vector 124 and any associated information (for example, vector tilt or vector rotation) may be locally stored into miscellaneous information 226 (FIG. 2) of navigation device 110.

Referring now to FIG. 4, a block diagram for one embodiment of the FIG. 2 location data 222 is shown, in accordance with the present invention. In alternate embodiments, location data 222 may include other components and configurations in addition to, or instead of, certain of those components and configurations discussed in conjunction with the FIG. 4 embodiment.

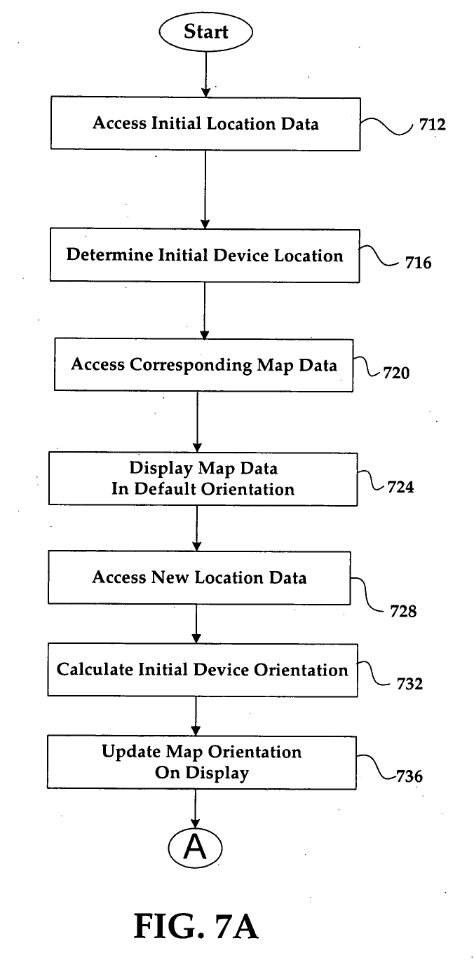

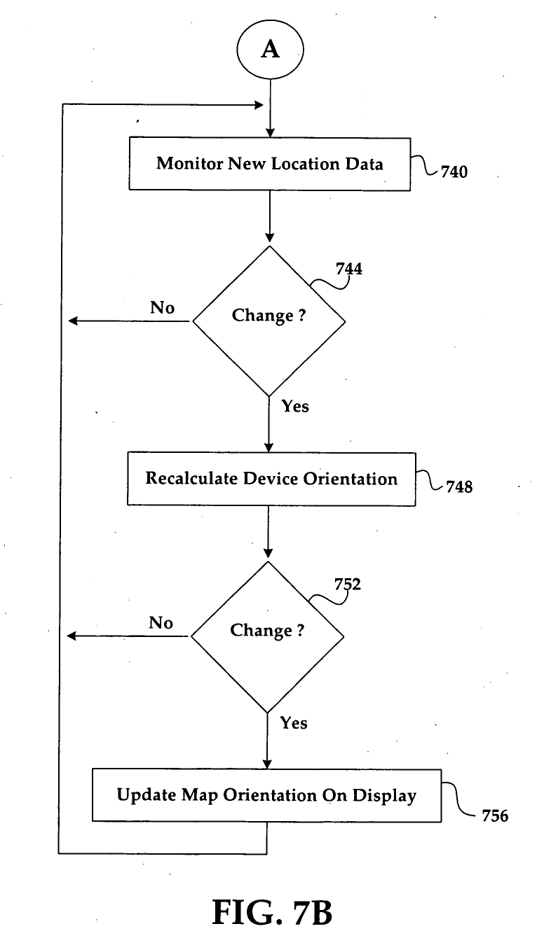

In the FIG. 4 embodiment, location information 412 may include any appropriate information to identify the specific geographical location of navigation device 110. For example, in certain embodiments, location data 222 may include a longitude parameter, a latitude parameter, an altitude parameter, and location measurement time. In the FIG. 4 embodiment, each set of location data 222 may be measured at a different time. For example, location data A 222(a) may be a current measurement of the physical location of navigation device 110. Each successive set of location data 222 may then be arranged in a chronological sequence according to when the respective sets of location data 222 are measured. A current orientation vector 124 or orientation data 224 for navigation device 110 may be estimated by calculating a straight line passing through a most recent location data A 222(a) and an immediately-preceding set of location data B 222(b). Further details regarding the utilization of location data 222 are further discussed below in conjunction with FIGS. 7A-B.

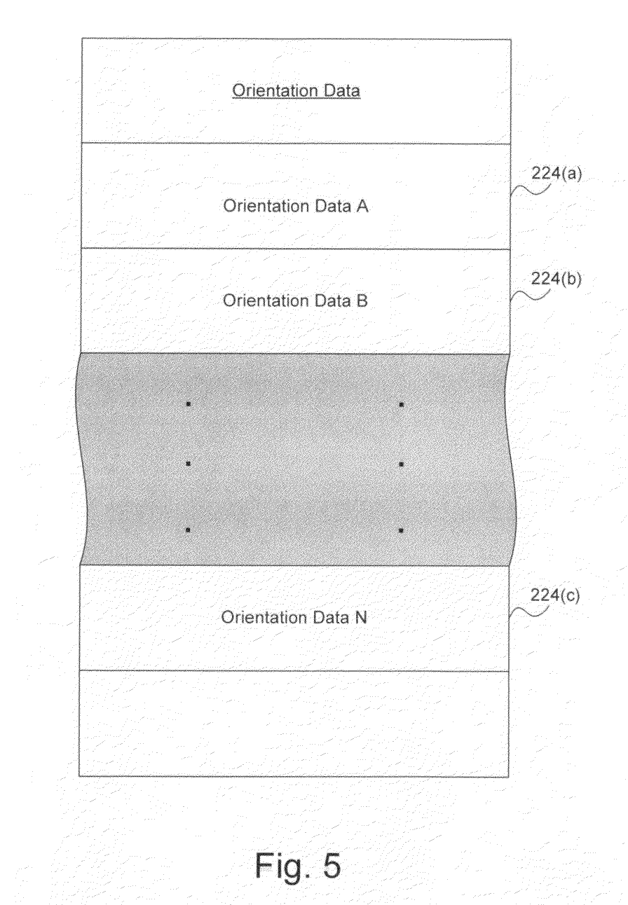

Referring now to FIG. 5, a block diagram for one embodiment of the FIG. 2 orientation data 224 is shown, in accordance with the present invention. In alternate embodiments, orientation data 224 may include other components and configurations in addition to, or instead of, certain of those components and configurations discussed in conjunction with the FIG. 5 embodiment.

In the FIG. 5 embodiment, orientation data 224 may include any appropriate information to identify the specific directional orientation of either navigation device 110 or of a current device user. For example, orientation data 224 may include specific compass coordinates that correspond to the direction of travel of navigation device 110. In certain embodiments, orientation data 224 may include a compass degree parameter within a standard range of zero to three-hundred sixty degrees, comprising North, South, East, and West quadrants. Orientation data 224 may also include an orientation measurement time.

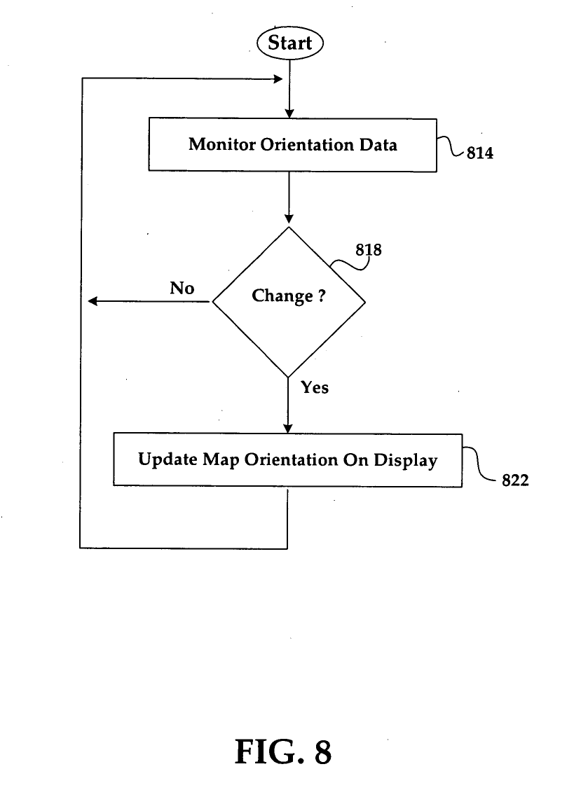

In the FIG. 5 embodiment, each set of orientation data 224 may be measured at a different time. For example, orientation data A 224(a) may be a current measurement of the physical orientation of navigation device 110. Each successive set of orientation data 224 may then be arranged in a chronological sequence according to when the respective sets of orientation data 224 are measured. In certain embodiments, a current orientation vector 124 for navigation device 110 may be estimated as being substantially equal to a most recent set of orientation data A 224(a). Further details regarding the utilization of orientation data 224 are further discussed below in conjunction with FIG. 8.

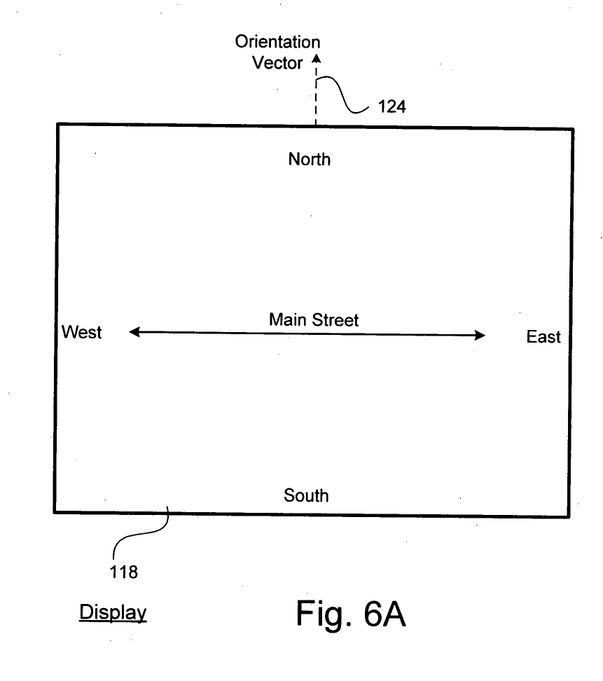

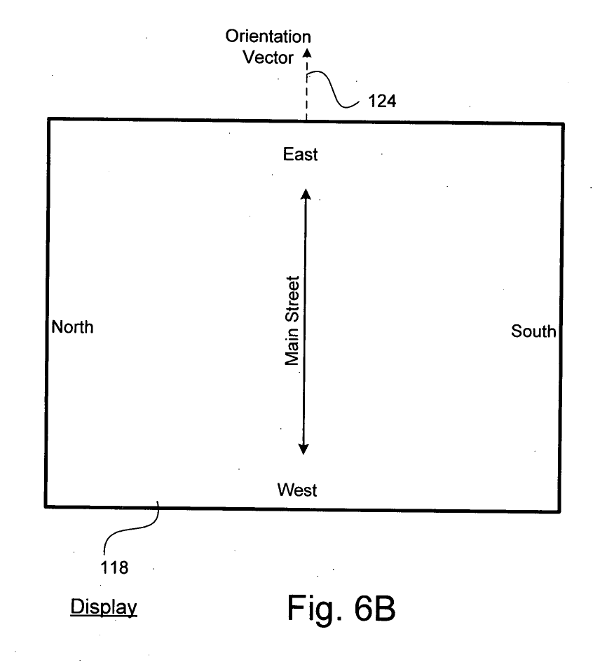

Referring now to FIGS. 6A and 6B, diagrams illustrating map data 218 displayed on the FIG. 1 display 118 are shown, in accordance with several embodiments of the present invention. The embodiments of FIGS. 6A and 6B are presented for purposes of illustration, and in alternate embodiments, display 118 may readily include other elements or configurations in addition to, or instead of, certain of those elements or configurations discussed in conjunction with the embodiments of FIGS. 6A and 6B.

In the FIG. 6A embodiment, map manager 216 initially displays map data 218 (FIG. 2) upon display 118 in a default map orientation that has a North coordinate at the top-center of display 118 and a South coordinate at the bottom-center of display 118. In the FIG. 6A example, for purposes of illustration, a street (Main Street) is shown running in an East-West direction. Map data 218 may alternately include any other features or components.

In the FIG. 6B embodiment, an updated version of the map data 218 from FIG. 6A is shown, after the current direction of travel of navigation device 110 has been rotated ninety degrees in a clockwise direction. In the FIG. 6B embodiment, map manager 216 now displays the same map data 218 from FIG. 6A on display 118 in an updated map orientation that has an East coordinate at the top-center of display 118 and a West coordinate at the bottom-center of display 118. In the FIG. 6B embodiment, the orientation vector 124 from FIG. 6A is still aligned with the top-center and bottom-center of display 118.

In the FIG. 6B example, Main Street is still shown running in an East-West direction, but the orientation of map data 218 has been rotated by map manager 216 in an orientation tracking procedure that tracks any changes in the current device orientation of navigation device 110, as quantified by orientation data 224, location data 222, or any other effective device orientation information. In accordance with the present invention, map manager 216 may thus update the map orientation of map data 218 on display 118 to match any incremental degree of change in the device orientation of navigation device 110. The present invention therefore provides a user-friendly map display that allows device users to consistently view a map orientation that advantageously matches and tracks the current device orientation of navigation device 110.

In certain embodiments, map manager 216 may support an automatic mode to constantly realign map data 218 with respect to an orientation vector 124 derived and updated from device orientation data 224, location data 222, or other appropriate information, as previously discussed above in conjunction with FIGS. 2 and 3A-3B. In certain other embodiments, map manager 124 may alternately utilize any other effective alignment reference(s) or technique(s) for realigning/updating map data 218 on display 118.

In addition, in certain embodiments, map manager 216 may include a refresh module that a device user may utilize to specify a refresh rate for realigning/updating map data 218 on display 118. For example, the refresh module may be selectively programmed with a relatively rapid refresh rate, so that map data 218 is immediately updated on display 118 whenever any change in device orientation occurs. Alternately, a less frequent refresh rate may also be selected to conserve processing resources. In certain embodiments, refresh operations for map data 218 may also be reserved for only those changes in device orientation that are greater than a user-selectable number of degrees.

Furthermore, in certain embodiments, map manager 216 may realign map data 218 by utilizing other effective manual techniques. For example, in certain operational environments, map manager 216 may support a manual mode in which a device user explicitly specifies current orientation data 224, display offsets, orientation defaults, or any other appropriate information for optimally realigning map data 218 on display 118. Additional details regarding enhanced techniques for optimally presenting map data 218 on display 118 are discussed below in conjunction with FIGS. 7-8.

Referring now to FIG. 7A, a flowchart of method steps for determining an initial device orientation for the FIG. 1 navigation device 110 is shown, in accordance with one embodiment of the present invention. The FIG. 7A embodiment is presented for purposes of illustration, and in alternate embodiments, the present invention may utilize steps and sequences other than certain of those steps and sequences discussed in conjunction with the FIG. 7A embodiment.

In the FIG. 7A embodiment, in step 712, a map manager 216 of a navigation device 110 accesses an initial set of location data 222 from any appropriate location data source. For example, in certain embodiments, the location data 222 may be provided by one or more location sensors 120 that specifically detect the current physical location of navigation device 110. In step 716, map manager 216 utilizes the initial location data 222 to determine an initial device location for navigation device 110. In step 720, map manager 216 accesses map data 218 corresponding to the initial device location from a local memory 116 of navigation device 110. Next, in step 724, map manager 216 displays the accessed map data 218 in a predefined default map orientation upon a display 118 of navigation device 110.

In step 728, map manager 216 accesses new current location data 222 from the location sensor 120 or other appropriate location data source. In certain embodiments, location sensor 120 may include a standard or enhanced Global Positioning System (GPS) receiver. In step 732, map manager 216 calculates an initial device orientation for navigation device 110 by utilizing any appropriate and effective techniques. For example, map manager 216 may determine the initial device orientation for navigation device 110 by calculating a straight line that begins at an initial location defined by the foregoing initial location data 222 accessed in step 712, and passes through a current location defined by the foregoing current location data 222 accessed in step 728.

The initial device orientation calculated by map manager 216 may be stored as an initial set of orientation data 224 in a local memory 116 of navigation device 110. In step 736, map manager 216 may then perform a map-orientation update procedure to update the default map orientation of map data 218 on display 118. The foregoing map-orientation update procedure thus advantageously provides an updated map orientation that is aligned with the initial device orientation calculated in step 732. The FIG. 7A process may then proceed to step 740 of FIG. 7B through connecting letter “A”.

Referring now to FIG. 7B, a flowchart of method steps for utilizing location data 222 to update map data on the FIG. 1 display 118 is shown, in accordance with one embodiment of the present invention. The FIG. 7B embodiment is presented for purposes of illustration, and in alternate embodiments, the present invention may utilize steps and sequences other than certain of those steps and sequences discussed in conjunction with the FIG. 7B embodiment.

In the FIG. 7B embodiment, in step 740, map manager 216 of navigation device 110 monitors the location data 222 generated by one or more location sensors 120 (FIG. 1) of navigation device 110 by utilizing any effective means or techniques. In step 744, map manager 216 determines whether any change has occurred in the location data 222 stored from location sensor(s) 120 into local memory 116. If no change has occurred in the location data 222, then the FIG. 7B process continues to monitor the location data 222 for any changes.

However, if a change has occurred in the location data 222, then in step 748, map manager 216 recalculates a current device orientation for navigation device 110 by utilizing any appropriate techniques. For example, map manager 216 may quantify the current device orientation by calculating a straight line that passes through two respective locations that are defined by the two most-recent sets of location data 222. In certain embodiments, the current device orientation may be stored as orientation data 224 in local memory 116.

Next, in step 752, map manager 216 determines whether any change has occurred in the current device orientation with respect to the immediately preceding device orientation by utilizing any effective techniques. For example, map manager 216 may compare corresponding respective sets of orientation data 224 to detect a change in device orientation. If no change has occurred in the device orientation, then the FIG. 7B process returns to step 740, and continues to monitor the location data 222 for any changes.

However, if a change has occurred in the device orientation, then in step 756, map manager 216 may then perform a map-orientation update procedure to update the current map orientation of map data 218 on display 118. The foregoing map-orientation update procedure thus advantageously provides an updated map orientation that is aligned with the current device orientation calculated in step 748. The FIG. 7B process may then return to step 740 and repeat.

Referring now to FIG. 8, a flowchart of method steps for utilizing orientation data 224 to update map data on the FIG. 1 display 118 is shown, in accordance with one embodiment of the present invention. The FIG. 8 embodiment is presented for purposes of illustration, and in alternate embodiments, the present invention may utilize steps and sequences other than certain of those steps and sequences discussed in conjunction with the FIG. 8 embodiment.

In the FIG. 8 embodiment, in step 814, map manager 216 of navigation device 110 monitors the orientation data 224 generated by one or more orientation sensors 120 (FIG. 1) of navigation device 110 by utilizing any effective means or techniques. In certain embodiments, the orientation sensors 120 may include a magnetic compass device and/or an inertial sensor device. Next, in step 818, map manager 216 determines whether any change has occurred in the orientation data 224 stored from orientation sensor(s) 124 (FIG. 1) into local memory 116 by utilizing any appropriate techniques. For example, map manager 216 may directly compare the two most-recent sets of orientation data 224 to detect a change in device orientation for navigation device 110.

If no change has occurred in the orientation data 224, then the FIG. 8 process may return to foregoing step 814, and continue to monitor the orientation data 224 for any changes. However, if a change has occurred in the orientation data 224, then in step 822, map manager 216 may perform a map-orientation update procedure to update the current map orientation of map data 218 on display 118. The foregoing map-orientation update procedure thus advantageously provides an updated map orientation that is aligned with the current device orientation determined in step 814. The FIG. 8 process may then return to step 814, and continue to monitor the orientation data 224 for any further changes.

In various implementations of the present invention, the FIG. 8 embodiment (map updates based upon orientation data 224) and the FIG. 7B embodiment (map updates based upon location data 222) may be utilized in a number of different effective configurations. For example, in one embodiment, the FIG. 7B embodiment may function as a primary system for triggering map updates, and the FIG. 8 embodiment may then serve as a secondary backup system that is utilized when location data 222 from FIG. 7B fails to change for a selectable pre-defined time duration (for example, when navigation device 110 is rotated at a stationary physical location).

In other implementations, the FIG. 7B embodiment and the FIG. 8 embodiment may be utilized in a concurrent and parallel manner. For example, in certain configurations, map manager 216 may combine orientation data 224 from FIG. 8 and location data 222 from FIG. 7B in any effective manner. For example, map manager 216 may combine location data 222 and orientation data 224 according to a weighted ratio, a non-weighted ratio, or on a time-sharing basis for triggering map updates on display 118. In certain appropriate circumstances, either the FIG. 7B embodiment or the FIG. 8 embodiment may also be economically utilized as a stand-alone system to individually trigger map updates.

The present invention may therefore be advantageously implemented to facilitate directly viewing map data 218 on navigation device 110 in a correctly-aligned map orientation, without requiring the device user to inconveniently visualize and mentally transpose traveling directions and map coordinates during a given course of travel. For all of the foregoing reasons, the present invention provides an improved system and method for effectively implementing an electronic navigation device.

The invention has been explained above with reference to certain embodiments. Other embodiments will be apparent to those skilled in the art in light of this disclosure. For example, the present invention may readily be implemented using configurations and techniques other than certain of those configurations and techniques described in the embodiments above. Additionally, the present invention may effectively be used in conjunction with systems or devices other than those described above. Therefore, these and other variations upon the discussed embodiments are intended to be covered by the present invention, which is limited only by the appended claims.

What is claimed is:

1. A system for implementing a navigation device, comprising:
a display coupled to said navigation device, said display being configured to display map data;
a map manager that coordinates a map update procedure to periodically realign said map data on said display according to device orientation data; and
a processor coupled to said navigation device to control said map manager.

2. The system of claim 1 wherein said navigation device is implemented as one of either a computer device, a mobile personal digital assistant device, an vehicle navigation device, or a consumer electronics device.

3. The system of claim 1 wherein said map manager periodically realigns said map data on said display to correspond with a current direction of travel for said navigation device.

4. The system of claim 1 wherein said map manager derives said device orientation data from device location data generated by a device location sensor of said navigation device.

5. The system of claim 4 wherein said location sensor includes a Global Positioning System receiver that generates said device location data including a longitude, a latitude, and an altitude of said navigation device.

6. The system of claim 4 wherein said map manager derives a current device orientation for said navigation device by extrapolating a current direction of travel from two most-recent sets of said device location data.

7. The system of claim 1 wherein said map manager accesses said device orientation data from a device orientation sensor of said navigation device.

8. The system of claim 7 wherein said device orientation sensor includes a magnetic compass device that generates said device orientation data including compass degree parameters within a standard range of zero to three-hundred sixty degrees, comprising North, South, East, and West quadrants.

9. The system of claim 7 wherein said device orientation sensor includes an inertial orientation sensor in which a starting point, all accelerations, and all changes of direction are detected to determine said device orientation data for said navigation device.

10. The system of claim 1 wherein said map manager performs said map update procedure based upon device location data generated by a device location sensor of said navigation device, and also based upon said device orientation data from a device orientation sensor of said navigation device.

11. The system of claim 10 wherein said map manager utilizes said device location data from said device location sensor as a primary means of performing said map update procedure, said map manager utilizing said device orientation data from said device orientation sensor as a secondary means of performing said map update procedure only when said device location data remains unaltered for more than a user-selectable duration.

12. The system of claim 10 wherein said map manager concurrently utilizes both said device location data from said device location sensor, and also said device orientation data from said device orientation sensor to perform said map update procedure, said map manager combining said device location data and said device orientation data according to one or more user-selectable combination techniques that alternately include a weighted combination ratio, a non-weighted combination ratio, and a time-sharing combination technique.

13. The system of claim 8 wherein said map manager accesses a magnetic-North/true-North conversion table to convert initial device orientation values from said magnetic compass device into said device orientation data.

14. The system of claim 1 wherein said map manager realigns said map data on said display to be aligned with an orientation vector that is calculated by said map manager based upon said device orientation data to indicate a direction of travel for said navigation device.

15. The system of claim 14 wherein a vector tilt value for said orientation vector with respect to said navigation device is selectively chosen and stored by a device user, said vector tilt value alternately being automatically controlled by gravitational sensors coupled to said navigation device to maintain said orientation vector in a substantially horizontal position.

16. The system of claim 14 wherein a vector rotation value for said orientation vector with respect to said navigation device is selectively chosen and stored by a device user to facilitate viewing said map data from an offset viewing position.

17. The system of claim 1 wherein said map manager includes a refresh module that a device user utilizes to specify a refresh rate for performing said map update procedure to periodically realign said map data on said display.

18. The system of claim 1 wherein said map manager performs said map update procedure to realign said map data on said display only when changes in said device orientation data are greater than a user-selectable number of rotational degrees.

19. The system of claim 1 wherein said map manager performs said map update procedure in a manual mode during which a device user manually provides map orientation coordinates for realigning said map data on said display.

20. The system of claim 1 wherein said navigation device includes a wireless communications module for accessing a computer device on a distributed computer network to download at least one of either additional map data, software instructions, or ancillary data for facilitating said map update procedure.

21. A method for implementing a navigation device, comprising:
displaying map data by utilizing a display that is coupled to said navigation device;
coordinating a map update procedure with a map manager to periodically realign said map data on said display according to device orientation data; and
utilizing a processor coupled to said navigation device to control said map manager.

22. The method of claim 21 wherein said navigation device is implemented as one of either a computer device, a mobile personal digital assistant device, an vehicle navigation device, or a consumer electronics device.

23. The method of claim 21 wherein said map manager periodically realigns said map data on said display to correspond with a current direction of travel for said navigation device, said map data including way points that provide a rudimentary view of at least one course of travel.

24. The method of claim 21 wherein said map manager derives said device orientation data from device location data generated by a device location sensor of said navigation device.

25. The method of claim 24 wherein said location sensor includes a Global Positioning System receiver that generates said device location data including a longitude, a latitude, and an altitude of said navigation device.

26. The method of claim 24 wherein said map manager derives a current device orientation for said navigation device by extrapolating a current direction of travel from two most-recent sets of said device location data.

27. The method of claim 21 wherein said map manager accesses said device orientation data from a device orientation sensor of said navigation device.

28. The method of claim 27 wherein said device orientation sensor includes a magnetic compass device that generates said device orientation data including compass degree parameters within a standard range of zero to three-hundred sixty degrees, comprising North, South, East, and West quadrants.

29. The method of claim 27 wherein said device orientation sensor includes an inertial orientation sensor in which a starting point, all accelerations, and all changes of direction are detected to determine said device orientation data for said navigation device.

30. The method of claim 21 wherein said map manager performs said map update procedure based upon device location data generated by a device location sensor of said navigation device, and also based upon said device orientation data from a device orientation sensor of said navigation device.

31. The method of claim 30 wherein said map manager utilizes said device location data from said device location sensor as a primary means of performing said map update procedure, said map manager utilizing said device orientation data from said device orientation sensor as a secondary means of performing said map update procedure only when said device location data remains unaltered for more than a user-selectable duration.

32. The method of claim 30 wherein said map manager concurrently utilizes both said device location data from said device location sensor, and also said device orientation data from said device orientation sensor to perform said map update procedure, said map manager combining said device location data and said device orientation data according to one or more user-selectable combination techniques that alternately include a weighted combination ratio, a non-weighted combination ratio, and a time-sharing combination technique.

33. The method of claim 28 wherein said map manager accesses a magnetic-North/true-North conversion table to convert initial device orientation values from said magnetic compass device into said device orientation data.

34. The method of claim 21 wherein said map manager realigns said map data on said display to be aligned with an orientation vector that is calculated by said map manager based upon said device orientation data to indicate a direction of travel for said navigation device.

35. The method of claim 34 wherein a vector tilt value for said orientation vector with respect to said navigation device is selectively chosen and stored by a device user, said vector tilt value alternately being automatically controlled by gravitational sensors coupled to said navigation device to maintain said orientation vector in a substantially horizontal position.

36. The method of claim 34 wherein a vector rotation value for said orientation vector with respect to said navigation device is selectively chosen and stored by a device user to facilitate viewing said map data from an offset viewing position.

37. The method of claim 21 wherein said map manager includes a refresh module that a device user utilizes to specify a refresh rate for performing said map update procedure to periodically realign said map data on said display.

38. The method of claim 21 wherein said map manager performs said map update procedure to realign said map data on said display only when changes in said device orientation data are greater than a user-selectable number of rotational degrees.

39. The method of claim 21 wherein said map manager performs said map update procedure in a manual mode during which a device user manually provides map orientation coordinates for realigning said map data on said display.

40. The method of claim 21 wherein said navigation device includes a wireless communications module for accessing a computer device on a distributed computer network to download at least one of either additional map data, software instructions, or ancillary data for facilitating said map update procedure.

41. A navigation device, comprising:
a display that is configured to display map data;
a map manager that coordinates a map update procedure to periodically realign said map data on said display according to device orientation data; and
a processor that controls said map manager.

42. The navigation device of claim 41 wherein said navigation device is implemented as a portable electronic device.

43. The navigation device of claim 42 wherein said navigation device includes a wireless communications module for accessing one or more devices on a distributed computer network to download at least one of either additional map data, software instructions, or ancillary data for facilitating said map update procedure.

44. The navigation device of claim 42 wherein said navigation device wirelessly connects to a laptop computer to download ancillary data for facilitating said map update procedure.

45. The navigation device of claim 44 wherein said ancillary data includes time information and date information that are updated by utilizing an IEEE 802 protocol.

46. The navigation device of claim 42 wherein said navigation device wirelessly connects to a satellite feed to download ancillary map data for performing said map update procedure.

47. The navigation device of claim 41 wherein said map manager periodically realigns said map data on said display to correspond with a current direction of travel for said navigation device.

48. The navigation device of claim 41 wherein said map manager derives said device orientation data from device location data generated by a device location sensor of said navigation device.

49. The navigation device of claim 41 wherein said map manager accesses said device orientation data from a device orientation sensor of said navigation device.

50. The navigation device of claim 41 wherein said map manager performs said map update procedure based upon device location data generated by a device location sensor of said navigation device, and also based upon said device orientation data from a device orientation sensor of said navigation device.
